(19) United States
(12) Patent Application Publication
(10) Pub. No.: US 2025/0087914 A1
(43) Pub. Date: Mar. 13, 2025

(54) TERMINAL BLOCK WITH SCREWLESS TERMINALS

(71) Applicant: Hubbell Incorporated, Shelton, CT (US)

(72) Inventors: Thomas L. Scanzillo, Monroe, CT (US); George M. Macdonald, Ridgefield, CT (US); Edward Bazayev, Kew Gardens, NY (US)

(21) Appl. No.: 18/826,553

(22) Filed: Sep. 6, 2024

Related U.S. Application Data
(60) Provisional application No. 63/537,169, filed on Sep. 7, 2023.

(51) Int. Cl. H01R 9/24

(52) U.S. Cl. CPC H01R 9/2416

(57) ABSTRACT

A screwless terminal block includes a housing having an interior, a plurality of wire openings and a plurality of actuator openings. A portion of the interior of the housing is hollow. Each of the plurality of wire openings provides access from an exterior of the housing to the hollow portion of the housing, and each of the plurality of actuator openings also provides access from the exterior of the housing to the hollow portion of the housing. A plurality of wire termination assemblies are positioned in the hollow portion of the housing such that one of the plurality of wire termination assemblies is accessible from one of the plurality of wire openings and one of the plurality of actuator openings. Each of the plurality of wire termination assemblies includes a wire terminal and an actuator extending at least partially through the one of the plurality of actuator openings in the housing. The actuator is interactive with the wire terminal such that movement of the actuator in a first direction causes the wire terminal to move from a closed position to an open position, and movement of the actuator in a second direction removes the mechanical load from the wire terminal so that the clamping member moves from the open position to the closed position.

### CROSS-REFERENCE TO RELATED APPLICATIONS

The present disclosure is based on and claims benefit from co-pending U.S. Provisional Patent Application No. 63/537,169 filed on Sep. 7, 2023 entitled “Terminal Block with Screwless Terminals” the contents of which are incorporated herein in their entirety by reference.

### FIELD

The present disclosure relates generally to terminal blocks and more particularly to terminal blocks with screwless terminals.

### DESCRIPTION OF THE RELATED ART

Present electrical wire terminations in many electrical wiring devices are either direct pressure type terminations or screw and clamp type terminations. In direct pressure type terminations, a terminal screw is tightened directly against an electrical wire to press the wire against a fixed plate. In screw and clamp type terminations, a wire is inserted between a fixed plate and a movable plate, and a terminal screw is tightened so that the wire is clamped between the plates. Screw terminations increase the time it takes to install the electrical wiring devices, especially multi-pole electrical wiring devices where two or more wires have to be connected to the wiring device. In addition, threaded fasteners, e.g., screws, are sensitive to torque requirements to achieve proper wire termination strength. Additionally, the screw terminations may loosen when subjected to vibrations.

### SUMMARY

A screwless terminal block according to an exemplary embodiment of the present disclosure includes a housing having an interior, a plurality of wire openings and a plurality of actuator openings. At least a portion of the interior is hollow and each of the plurality of wire openings provides access from an exterior of the housing to the hollow portion of the interior of the housing. Each of the plurality of actuator openings provides access from the exterior of the housing to the hollow portion of the interior of the housing. A plurality of wire termination assemblies are positioned in the hollow portion of the interior of the housing such that one of the plurality of wire termination assemblies is accessible from one of the plurality of wire openings and one of the plurality of actuator openings. Each of the plurality of wire termination assemblies includes a wire terminal including a clamp brace electrically connected to a clamping member, the clamping member being movable between a closed position where a wire can be clamped between the clamping member and the clamp brace, and an open position where the wire can be inserted through the one of the plurality of wire openings in the housing and between the clamping member and the clamp brace. Each of the plurality of wire terminal assemblies also includes an actuator extending at least partially through the one of the plurality of actuator openings in the housing, the actuator being interactive with the clamping member such that movement of the actuator in a first direction causes the actuator to apply a mechanical load to the clamping member causing the clamping member to move from the closed position to the open position, and movement of the actuator in a second direction removes the mechanical load from the clamping member so that the clamping member moves from the open position to the closed position. A clamp brace of at least one of the plurality of wire terminal assemblies is electrically connected to a clamp brace of at least one other of the plurality of wire terminal assemblies.

A screwless wire connector according to an illustrative embodiment of the present disclosure includes a housing including at least one cavity, at least one housing wire opening and at least one actuator opening extending between the at least one cavity and an outer surface of the housing. The at least one housing wire opening is arranged at an angle relative to the at least one cavity and a plug member for mating with an electrical wiring device. At least a portion of the plug member includes a portion of the at least one cavity, and wherein the plug member has at least one slot for receiving a contact blade aligned with the portion of the at least one cavity. At least one contact assembly is positioned within the at least one cavity, the at least one contact assembly including a wire terminal including a clamp brace electrically connected to a clamping member, the clamping member being movable between a closed position where a wire can be clamped between the clamping member and the clamp brace, and an open position where the wire can be inserted through the at least one housing wire opening and between the clamping member and the clamp brace. The at least one contact assembly also includes an actuator extending at least partially through at the at least one of the plurality of actuator openings in the housing, the actuator being interactive with the clamping member such that movement of the actuator in a first direction causes the actuator to apply a mechanical load to the clamping member causing the clamping member to move from the closed position to the open position, and movement of the actuator in a second direction removes the mechanical load from the clamping member so that the clamping member moves from the open position to the closed position. A clamp brace of at least one of the plurality of wire terminal assemblies is electrically connected to at least one flexible contact positioned within the plug member for receiving the contact blade.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a top perspective view of a screwless terminal block according to an illustrative embodiment of the present disclosure;

FIG. 2 is a top perspective view of a screwless terminal block according to an illustrative embodiment of the present disclosure including a bus bar;

FIG. 3 is an perspective view of the screwless terminal block according to an illustrative embodiment of the present disclosure and a mounting plate for mounting the terminal block to a structure;

FIG. 4 is a top perspective view of the screwless terminal block according to the illustrative embodiment of the present disclosure depicted in FIG. 3 mounted to a structure;

FIG. 5 is a bottom plan view of the screwless terminal block of FIG. 1, illustrating electrical wires being connected thereto according to an illustrative embodiment of the present disclosure;

FIG. 6 is a perspective view of the screwless terminal block of FIG. 1 according to an illustrative embodiment of the present disclosure illustrating the position of components while electrical wires are connected;

FIG. 7 is a partial cutaway view of a portion of the screwless terminal block of FIG. 4 according to an illustrative embodiment of the present disclosure taken from detail 7;

FIG. 8 is a perspective view of a portion of the internal components of the screwless terminal block of FIG. 4 according to an illustrative embodiment of the present disclosure;

FIG. 9 is a side view of a portion of the internal components of the screwless terminal block of FIG. 4 according to an illustrative embodiment of the present disclosure;

FIGS. 10-12 are side views of a portion of the internal components of the screwless terminal block of FIG. 4 according to an illustrative embodiment of the present disclosure for describing its operation; and

FIG. 13 is the top perspective view of a screwless terminal block according to another illustrative embodiment of the present disclosure;

FIG. 14 is a different top perspective view of the screwless terminal block of FIG. 13 according to an illustrative embodiment of the present disclosure;

FIG. 15 is a bottom view of the screwless terminal block of FIG. 13 according to an illustrative embodiment of the present disclosure for describing its operation;

FIG. 16 is a bottom view of a screwless terminal block according to another illustrative embodiment of the present disclosure;

FIG. 17 is a perspective view of a screwless connector according to an illustrative embodiment of the present disclosure which mates with electrical wiring devices;

FIG. 18 is a front perspective view of the screwless connector of FIG. 17 according to an illustrative embodiment of the present disclosure;

FIG. 19 is a rear perspective view of the screwless connector of FIG. 17 according to an illustrative embodiment of the present disclosure;

FIG. 20 is a cutaway portion view of the screwless connector of FIG. 18 according to an illustrative embodiment of the present disclosure;

FIG. 21 is a top view of a housing of the screwless connector of FIG. 17 according to an illustrative embodiment of the present disclosure;

FIG. 22 is an enlarged view of internal components of the screwless connector of FIG. 17 according to an illustrative embodiment of the present disclosure;

FIG. 23 is a top view of the housing of the screwless connector of FIG. 17 and internal components according to an illustrative embodiment of the present disclosure; and

FIG. 24 is a partial top view of the housing of the screwless connector of FIG. 17 and internal components according to an illustrative embodiment of the present disclosure.

### DETAILED DESCRIPTION

Exemplary embodiments of wire termination assemblies according to the present disclosure are shown and described. The wire termination assemblies contemplated by the present disclosure do not use screws or like fasteners to connect electrical wires to the termination assembly. As such, the wire termination assemblies may be referred to as screwless wire termination assemblies or screwless terminations or screwless terminal blocks.

For ease of description, the wire termination assemblies may also be referred to herein as the “terminations” in the plural and the “termination” in the singular. In addition, the electrical conductors may also be referred to as the “wires” in the plural and the “wire” in the singular. Further, the electrical conductors can be any size wire used to conduct electricity, such as 14 AWG wire, 12 AWG wire, 10 AWG wire or 8 AWG wire. Generally, 14 AWG wires are rated for between 15 and 18 amps, 12 AWG wires are rated for between 20 and 25 amps, 10 AWG wires are rated for between 25 and 30 amps, and 8 AWG wires are rated for between 35 and 40 amps. The electrical conductors may include stranded and or solid conductors.

A screwless termination or terminal block according to an illustrative embodiment of the present disclosure is shown in FIGS. 1-12 and is referred to herein as screwless termination or terminal block 10. Screwless terminal block 10 has a housing 12 that includes a pair of wire attachment portions 16 and 18. Housing 12 is preferably made of a suitable electrical insulating material, such as plastic, including injection molded thermoplastic, and can be a standalone unit or configured to fit within an electrical enclosure.

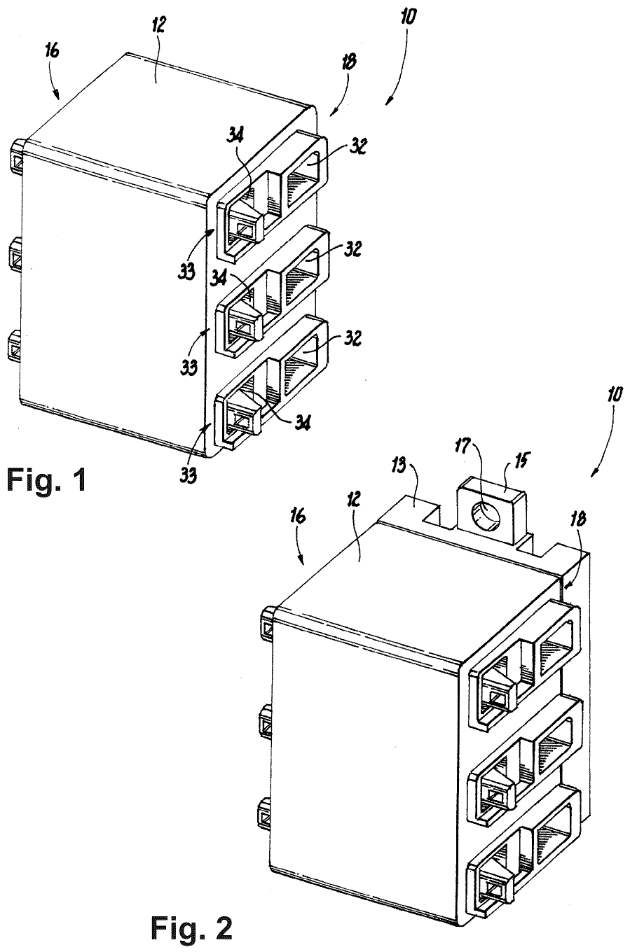

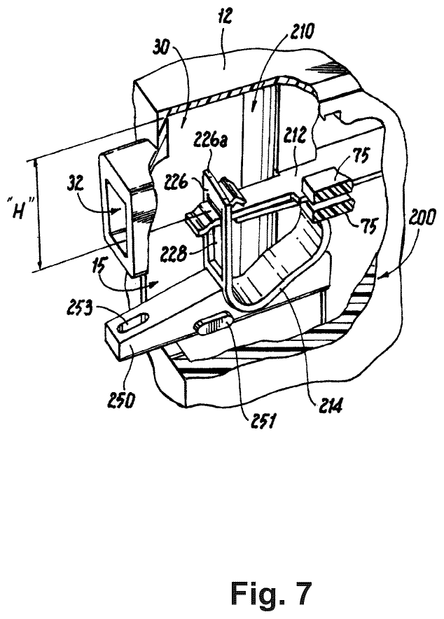

Within housing 12 are the components that interconnect two or more wires entering wire attachment portions 16 and 18. Each wire attachment portion 16 and 18 may be secured to or integrally formed into the housing 12. Each wire attachment portion 16, 18 may include one or more terminal access portions 33, each including an actuator opening 34 and a wire opening 32. Housing 12 may include one or more chambers or cavities 30 as shown in FIG. 7. According to the present illustrative embodiment, housing 12 includes a chamber or cavity 30 associated with each terminal access portion 33, each individually accessible via a wire opening 32 and a corresponding actuator opening 34. Each chamber or cavity 30 is configured to receive and position a wire terminal assembly 200 which may also be referred to as wire termination assembly 200 within the housing 12, as shown in FIG. 7. In the present exemplary embodiment, wire attachment portion 16, seen in FIGS. 1 and 2, includes three terminal access portions 33, each including a wire opening 32 and an actuator opening 34. In the present exemplary embodiment, wire attachment portion 18 includes three terminal access portions 33, each including a wire opening 32 and an actuator opening 34. In this configuration, each wire opening 32 and a corresponding actuator opening 34 provide access from an exterior of the housing 12 to one of the plurality of chambers or cavities 30 and a corresponding wire termination assembly 200. As will be described in the following detailed description, each wire termination assembly 200 is configured to receive and clamp a wire, such as wire 700 shown in FIGS. 4-6. Each wire termination assembly 200 may be electrically connected to one or more other wire termination assemblies 200 for interconnecting two or more of the wires 700.

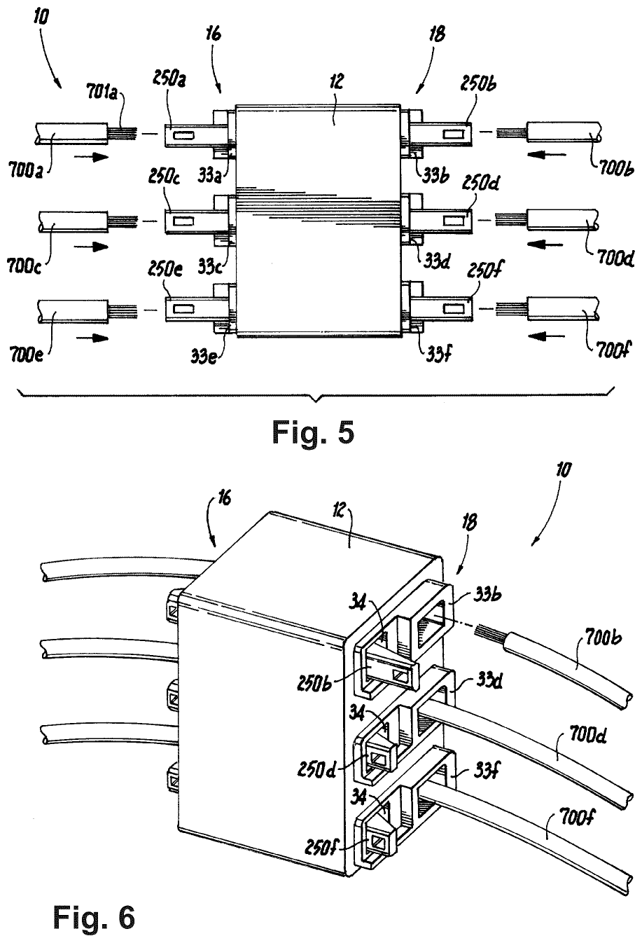

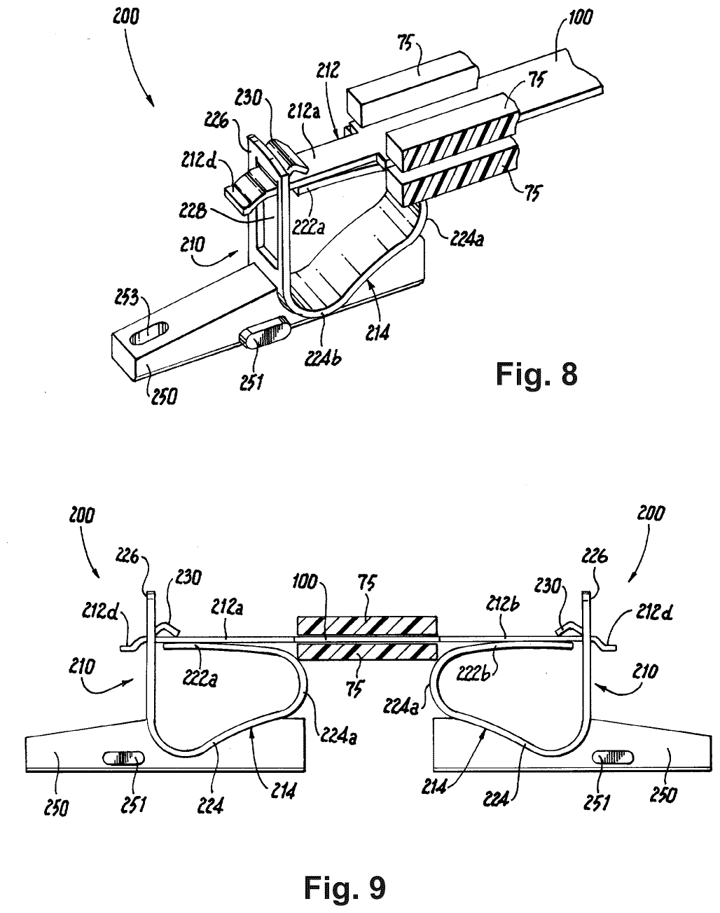

As described with respect to FIG. 5-9, wire attachment portion 16 includes terminal access portions 33a, 33c and 33e and wire attachment portion 18 includes terminal access portions 33b, 33d and 33f. Each terminal access portion provides access to a termination assembly 200 positioned within housing 12 (FIG. 7). Jumpers or interconnections may be provided between two or more termination assemblies 200 for interconnecting two or more wires 700 attached to the termination assemblies. According to the present illustrative embodiment as shown in FIGS. 8 and 9, a jumper 100 may be arranged between pairs of wire termination assemblies 200. In the illustrative embodiment of the present disclosure, jumper 100 may be a separate section of conductive material abutting and/or mechanically joined to adjacent wire termination assemblies 200. For example, jumper 100 may be a section of copper, aluminum, steel, or spring steel, etc. that is welded or otherwise mechanically joined to portions of the wire termination assemblies 200 (e.g., to clamp brace 212). Alternatively, a single section of material may extend between wire termination assemblies 200 forming the jumper 100 as well as the clamp brace portions 212 of wire termination assemblies 200. Referring to FIG. 5, according to the present illustrative embodiment, the wire termination assembly 200 positioned adjacent terminal access portion 33a is electrically connected to the wire termination assembly 200 positioned adjacent terminal access portion 33b. The wire termination assembly 200 positioned adjacent terminal access portion 33c is electrically connected to the wire termination assembly 200 positioned adjacent terminal access portion 33d. The wire termination assembly 200 positioned adjacent terminal access portion 33e is electrically connected to the wire termination assembly 200 positioned adjacent terminal access portion 33f. This configuration thus allows three sets of wires 700 to be individually electrically connected.

A wire termination assembly 200 according to an illustrative embodiment of the present disclosure is shown in FIGS. 7-12. Each wire termination assembly 200 is configured to receive and clamp a wire, such as wire 700. Wire 700 may be an insulated wire including an electrically conductive wire 701 (typically copper, aluminum, etc.) and one or more insulating covers or coatings 702, seen in FIG. 24. While the present disclosure may refer to clamping the wire 700 or electrically interconnecting the wires 700, it will be appreciated that this is understood to mean that the bare conductive wire 701 is being clamped and electrically interconnected. In the exemplary embodiment shown, each wire termination assembly 200 includes a wire terminal 210 and an actuator 250. Wire terminal 210 may be made of one or more electrically conductive materials which may include brass, copper, aluminum or spring steel. In an exemplary embodiment, at least a portion of the wire terminal 210 is made of an electrically conductive resilient material with sufficient stiffness to flex when a mechanical load is applied and return to its normal position when the mechanical load is removed. An example of such an electrically conductive resilient material is spring steel. The wire terminal 210 can be formed as a unitary structure or the wire terminal 210 can be formed from individual components which may be maintained in electrical contact by spring force provided by the materials used. According to the present illustrative embodiment, the wire terminal 210 is formed from individual components that are secured together by, for example, a solder joint, a brazed joint, or a welded joint. The actuator 250 is made of a suitable rigid electrical insulating material, such as a plastic material. An example of a plastic material is injection molded thermoplastic. The actuator 250 may also be referred to herein as a “plunger” in the singular and “plungers” in the plural.

Continuing to refer to FIGS. 7-9, the wire terminal 210 is a mechanical clamping terminal formed from one or more clamping members 214 and one or more clamp braces 212. According to the present illustrative embodiment, each wire terminal 210 is formed from one clamping member 214 and one clamping brace 212. The wire terminal 210 is designed to deflect under a mechanical load applied by the plunger 250 and recover to an initial shape when at least a portion of the mechanical load is removed. The energy stored by the one or more clamping members 214 should be sufficient to apply a constant and continuous force to mechanically secure one or more wires, e.g., wires 700 shown in FIGS. 4-6, to the wire terminal 210. The clamp brace 212 is a fixed terminal body that may be a substantially planar shaped member or an arcuate shaped member having a first end 212a in electrical contact with end portion 222a of clamping member 214. The clamp brace 212 may be maintained in electrical contact with end portion 222a of clamping member 214 by spring force provided by clamping member 214. Alternatively, the clamp brace 212 may be secured to end portion 222a of the clamping member 214 by, for example, a solder joint, a brazed joint, or a welded joint. According to the present illustrative embodiment, the clamp brace 212 has a second end 212b in electrical contact with end portion 222b of clamping member 214 of adjacent wire terminal 210. The clamp brace 212 may be maintained in electrical contact with end portion 222b by spring force provided by clamping member 214. Alternatively, the clamp brace 212 may be secured to end portion 222b of the clamping member 214 by, for example, a solder joint, a brazed joint, or a welded joint. Preferably, at least a portion of the middle section of the clamp brace 212 is fixed or secured to a slotted portion 75 of the housing 12 to limit or prevent flexing of the middle section of the clamp brace 212 during operation of the wire termination assemblies 200.

Referring to FIGS. 8-12, in the exemplary embodiment shown, the clamping member 214 may be a biasing member. In the exemplary embodiment shown, the biasing member is a spring that includes an end portion 222a, a spring member 224 and a clamp arm 226. The end portion 222a can be a substantially planar shaped member or an arcuate shaped member that is configured to mate with the clamp brace 212 and as described above, may be secured to the clamp brace 212 by, for example, a solder joint, a brazed joint, or a welded joint. The spring member 224 has a lower lobe 224a and an upper lobe 224b. The lower lobe 224a and the upper lobe 224b are configured to interact with the plunger 250 so that movement of the plunger 250 relative to the spring member 224 is translated to the application of a mechanical load on the spring member 224 or the removal of at least a portion of the mechanical load on the spring member 224.

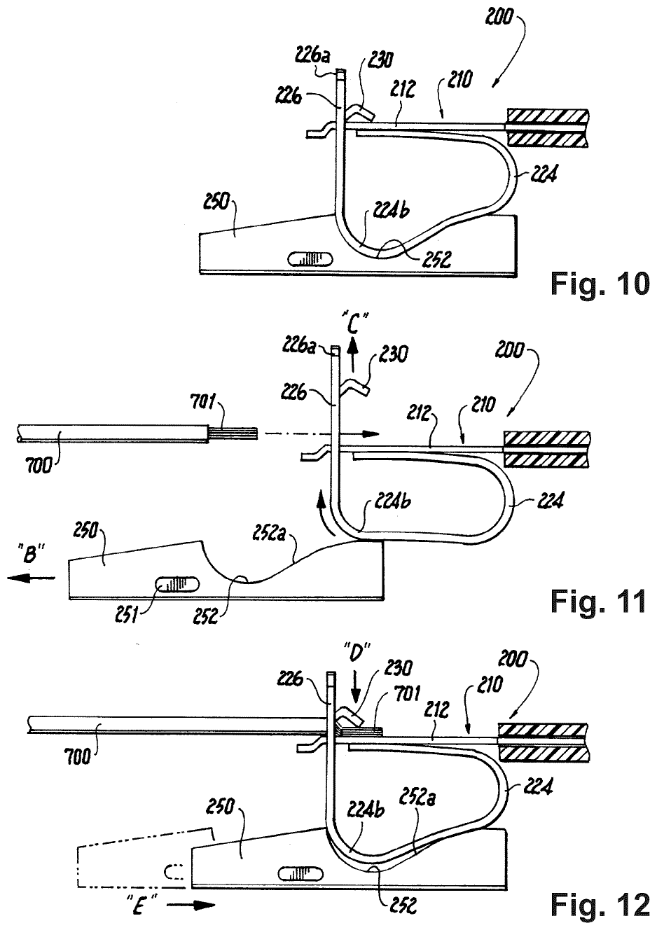

The plunger 250 can be a rectangular shaped member having one or more longitudinal raised ribs 251 extending along portions of plunger 250. Each longitudinal raised rib 251 is slidingly received in a corresponding notch or groove (not shown) provided along an inside side surface 15 of housing 12 (e.g., see FIG. 7). Plunger 250 may also include an orifice 253 extending therethrough. Orifice 253 is dimensioned to allow a tool (e.g., a screwdriver) to be inserted therein to provide the operator of the device with additional leverage for moving the plunger 250 between an open and a closed position. Referring to FIG. 11, plunger 250 includes a notch 252 that is configured to receive the upper lobe 224b of the spring member 224. The notch 252 has a camming surface 252a that rides along the spring member 224 when the plunger 250 is moved in the direction of arrow “B” to the open position, applying a mechanical load on the spring member 224 causing the spring member 224 to deflect in the direction of arrow “C” toward the open position. A clamp arm 226 extends from the upper lobe 224b of the spring member 224 toward the clamp brace 212, as shown. The clamp arm 226 has an elongated opening 228 and includes a wire press member 230 extending inward toward end portion 222 of the clamping member 214 (e.g., see FIG. 8). The elongated opening 228 is configured to receive a distal end portion 212d of the clamp brace 212. Wire press member 230 may be formed in situ with elongated opening 228 during manufacture by permanently bending a portion of the material cut from the elongate opening 228 to form the wire press member 230. Alternatively, wire press member 230 may be formed as a separate piece and welded or otherwise connected to clamp arm 226 as shown. The wire press member 230 is configured to contact and press the bare wire 701 seen in FIGS. 11 and 12, against the clamp brace 212 when the bare wire 701 is positioned between the clamp brace 212 and the wire press member 230 and the clamping member 214 is moved to the closed position, as shown in FIG. 12. The clamp arm 226 is movable relative to the clamp brace 212 between the closed position, seen in FIGS. 10 and 12, and the open position, seen in FIGS. 11 and 12 by moving plunger 250 linearly in directions “E” and “B” in and out of the housing 12. It should be noted that during movement of plunger 250, the distal end portion 226a of clamp arm 226 moves from the closed position illustrated in FIGS. 7 and 10 to the raised open position illustrated in FIG. 11. Accordingly, sufficient space “H” should be provided within housing 12 allowing for this movement (e.g., see FIG. 7).

The wire terminal 210 can connect to electrical conductors of different sizes. For example, if the electrical wiring 700 is rated for 20 amps, then the wire terminal 210 should also be configured and rated for at least 20 amps. The wire size, i.e., the bare conductor size, for 20 amps is 12 AWG wire such that the clamp arm 226 should be able to move to an open position where the outer diameter of 12 AWG wire can fit. As another example, if the electrical wiring 700 is rated for 30 amps, then the wire terminal 210 should also be rated for at least 30 amps. The wire size, i.e., the bare conductor size, for 30 amps is 10 AWG wire such that the clamp arm 226 should be able to move to an open position where the outer diameter of 10 AWG wire can fit. As another example, if the electrical wiring 700 is rated for 40 amps, then the wire terminal 210 should also be rated for at least 40 amps. The wire size, i.e., the bare conductor size, for 40 amps is 8 AWG wire such that the clamp arm 226 should be able to move to an open position where the outer diameter of 8 AWG wire can fit.

The spring member 224 is made of an electrically conductive resilient material with sufficient stiffness to flex when the plunger 250 pushes the spring member 224 from the closed position, seen in FIGS. 10 and 12, to the open position, seen in FIG. 11. As noted, when in the closed position, the spring member 224 applies a force (e.g., a spring force) through the wire press member 230 to the bare wire conductor 701 inserted between the wire press member 230 and the clamp brace 212, as shown in FIG. 12. As an example, the spring member 224 can be made of metal, such as spring steel. The biasing force (, e.g., spring force) exerted by the spring member 224 clamping a wire between the wire press member 230 and the clamp brace 212 should be sufficient to apply a constant and continuous force on the wire 701 to electrically couple or connect the wire 701 to the wire terminal 210 in various temperatures and environmental conditions. The spring member 224 is configured so that it is normally biased toward the closed or normal position, i.e., in the direction of arrow “D” which is away from the clamp brace 212, as seen in FIG. 12. In the normal position of the spring member 224 without a conductor inserted into the elongated opening 228, the wire press member 230 of the clamp arm 226 can contact the clamp brace 212, as shown in FIG. 10.

Referring to FIGS. 5-12, an exemplary embodiment of a use scenario for the terminal block 10 described herein is shown. To connect wires within enclosure 12, an installer, e.g., an electrician, strips the insulation from the distal end of each wire 700a-700f exposing the bare wires 701. In the exemplary embodiment shown in FIGS. 5 and 6, terminal block 10 has six wire terminal assemblies 200, seen in FIGS. 10-12, and is capable of joining three individual sets of wires. According to the present illustrative embodiment of the present disclosure, the six wires include wire 700a to be joined to wire 700b, wire 700c to be joined to wire 700d and wire 700e to be joined to wire 700f.

A distal end portion of the plunger 250 for each wire terminal assembly 200 extends through the actuator opening 34 in the wire attachment portions 16 or 18 of the housing 12. The exposed distal ends (701) of each wire 700 will extend into housing 12 through the corresponding wire opening 32 as shown in FIG. 1. The distal end portions of the plungers 250 extending from wire terminal assembly 200 are moved, e.g., pulled, in the direction of arrow “B,” seen in FIG. 11, which in this case is outward relative to the housing 12. Moving the plunger 250 in the direction of arrow “B” causes the camming surface 252a of the notch 252 in the plunger 250 to ride along the spring member 224 applying a mechanical load on the spring member 224. Applying a mechanical load on the spring member 224, causes the spring member 224 to deflect in the direction of arrow “C”, seen in FIG. 10, from the closed position toward the open position. In this open position, the stripped and bare distal end portions 701 of electrical wires 700a-700f are then inserted into the appropriate wire openings 32 in the wire attachment portions 16 or 18 of the housing 12. The wire openings 32 help guide the bare ends of the wires 700 into the portion of the elongated opening 228 of the clamping member 214 between clamp brace 212 and wire press member 230. When the bare end of a wire 700 is positioned between the clamp brace 212 and the wire press member 230, the respective plunger 250 is moved, e.g., pushed in the direction of arrow “E,” back in toward the actuator opening 34 (see FIG. 12) to the closed position. Moving the plunger 250 in the direction of arrow “E” removes at least a portion of the mechanical load applied by the plunger 250 on the spring member 224 so that the energy stored by the spring member 224 moves the spring member 224 to the closed position with sufficient force to secure or clamp the bare wire 701 between the clamp brace 212 and the wire press member 230 completing an electrically conductive path between the wire 700 and the wire termination assembly 200. It is noted that when the plunger 250 is moved in the first direction of arrow “B” to the open position, plunger 250 extends out of the wire attachment portion 16 or 18 of the housing 12 a distance that is greater than when the plunger 250 is moved in the second direction of arrow “E” to the closed position. For example, as shown in FIG. 6, plungers 250d and 250f are shown in the closed position. Plunger 250b is shown in the open position and extends further from wire attachment portion 18 of the housing 12 as shown. The second direction may be a direction that is opposite the first direction. In addition, it is noted that when the plunger 250 is moved to the open position or the closed position, the plunger 250 may remain in the open or the closed position until the plunger 250 is manually moved to the other position.

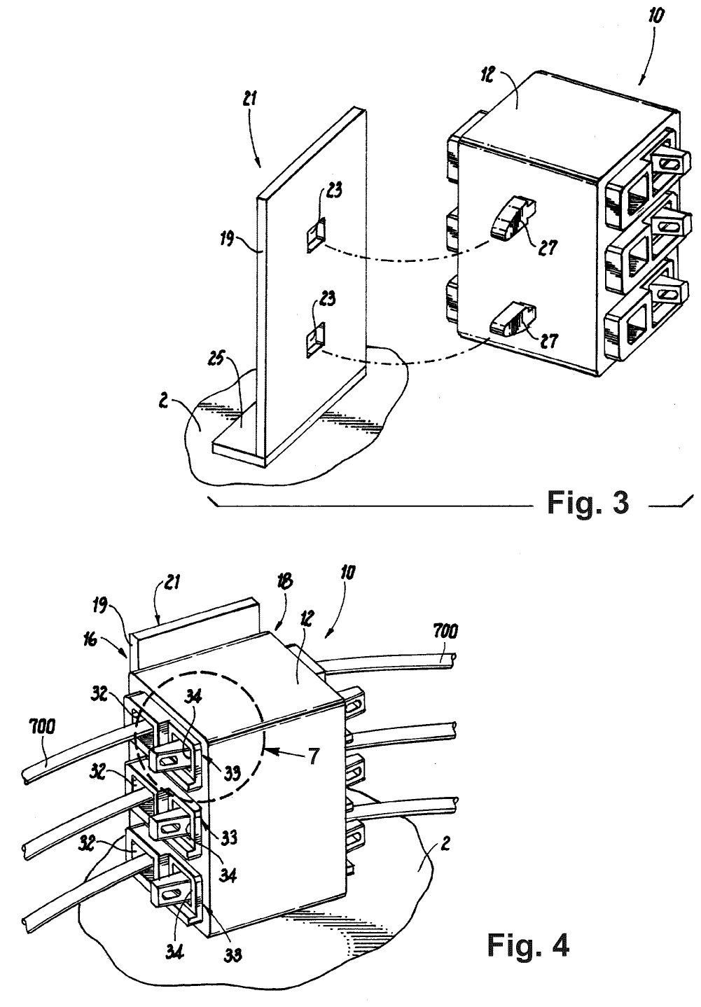

Housing 12 may be removably secured to a structure if desired. For example, according to the illustrative embodiment depicted in FIG. 3, housing 12 may be provided with expansion clips 27 that connect to a mount 21. Mount 21 includes an L-shaped plate 19 including orifices 23 shaped, seen in FIG. 3, dimensioned and positioned to receive the expansion clips 27. Base portion 25 of mount 21 may be mechanically secured to a structure 2 in any suitable manner including for example, by screws, weld, etc.

Housing 12 may also be secured to a structure 2 such that one or more of the termination assemblies 200 are connected to a common ground or voltage bus. For example, as shown in FIG. 2, a plate 13 having a bus bar 15 mounted thereto may be secured to housing 12. Bus bar 15 is an electrically conductive material and may be, for example, brass, copper, aluminum, steel, etc. One or more of the termination assemblies 200 within housing 12 may be electrically connected to bus bar 15 by providing an electrically conductive jumper (not shown) from bus bar 15 to the clamp brace 212 associated with the one or more termination assemblies 200. A hole 17 is provided in bus bar 15 allowing the bus bar 15 to be attached, for example, to an appropriate ground or voltage bus using a suitable mechanical fastener.

It will be appreciated that many variations of the present termination or terminal blocks are possible. For example, in the above-described embodiment, each of the wire attachment portions 16 and 18 includes three terminal access portions 33 providing access to three wire termination assemblies 200, each via an actuator opening 34 and corresponding wire opening 32. Each wire termination assembly 200 accessible via wire attachment portion 16 is jumped or connected to a single corresponding wire termination assembly 200 accessible via wire attachment portion 18. Accordingly, it can be said that wire termination assemblies 200 are in a 1 to 1 relationship.

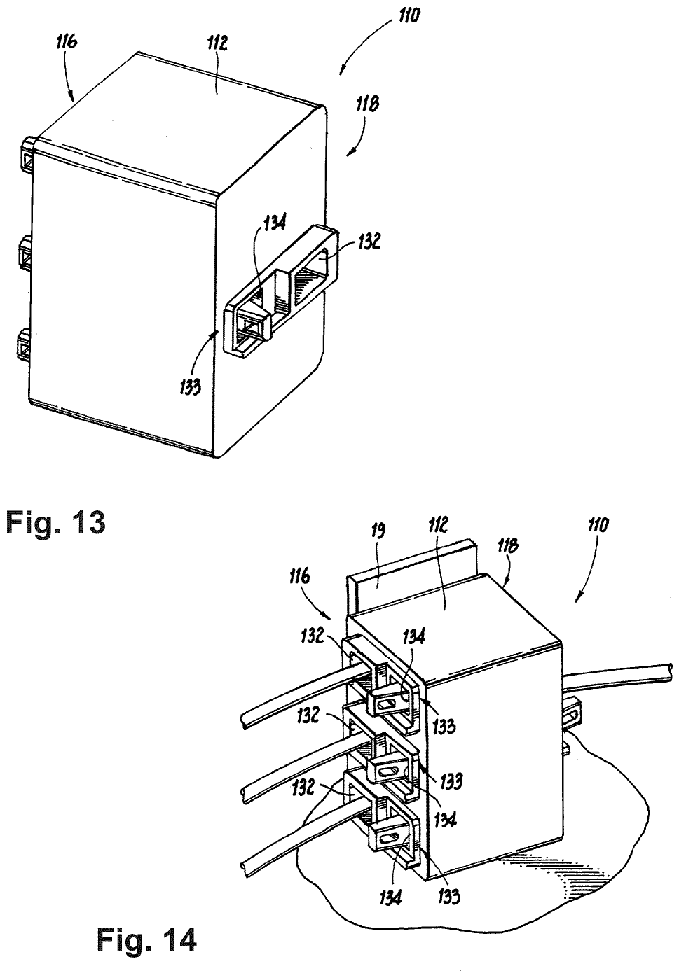

A termination or terminal block according to another illustrative embodiment of the present disclosure is shown in FIGS. 13-15 and is referred to herein as termination or terminal block 110. Terminal block 110 has a housing 112 that includes a pair of wire attachment portions 116 and 118. Housing 112 is preferably made of a suitable electrical insulating material, such as plastic, including injection molded thermoplastic, and can be a standalone unit or configured to fit within an electrical enclosure. Within the housing 112 are the components that interconnect two or more wires connected to wire attachment portions 116 and 118. Each wire attachment portion 116 and 118 may be secured to or integrally formed into the housing 112. According to the present illustrative embodiment, wire attachment portion 116 includes three terminal access portions 133, each including an actuator opening 134 and a wire opening 132. Wire attachment portion 118 includes a single terminal access portion 133 including an actuator opening 134 and a wire opening 132. Similar to that described with respect to previous embodiments, housing 112 may include one or more chambers or cavities configured to receive and position one or more wire termination assemblies 200 within housing 112. The chambers or cavities and wire termination assemblies 200, seen in FIGS. 7-12, positioned within housing 112 are substantially similar to the corresponding structures described with respect to the above embodiments and for reasons of brevity will not be described again in detail.

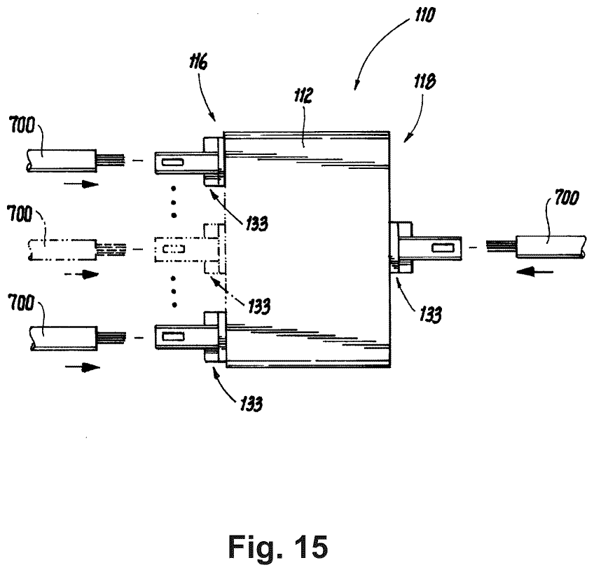

According to the illustrative embodiment of the present disclosure, in this configuration, each of the wire termination assemblies 200 are electrically interconnected. As described with respect to the previous embodiment, this interconnection may be achieved utilizing one or more individual jumpers and/or appropriately shaped clamp braces 212 (e.g., see FIG. 8). The present illustrative embodiment thus allows multiple wires (e.g., three) to be connected to one wire. Accordingly, it can be said that the wire termination assemblies 200 associated with each terminal access portion 133 are in a 3 to 1 or 1 to 3 relationship. As illustrated in FIG. 15, any number of terminal access portions 133 (and associated termination assemblies 200) may be provided in wire attachment portion 116, theoretically allowing virtually an unlimited number of wires to be attached to a single wire. Of course, any number of termination assemblies 200 and associated terminal access portions 133 may also be provided on wire attachment portion 118. The termination assemblies 200 associated with each terminal access portion 133 may be interconnected via appropriate jumpers to provide as many configurations of connections as desired.

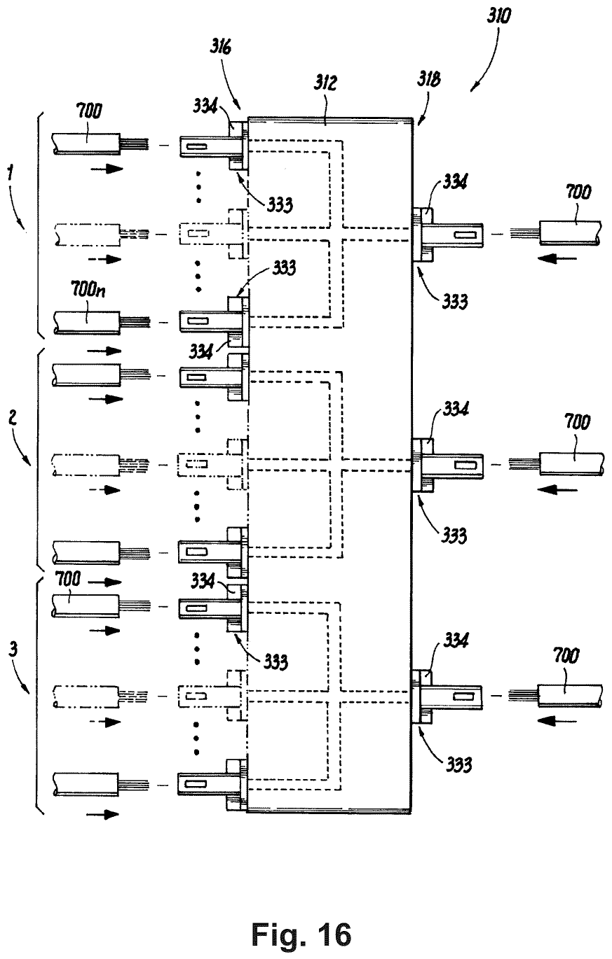

A termination or terminal block according to another illustrative embodiment of the present disclosure is shown in FIG. 16 and is referred to herein as termination or terminal block 310. Terminal block 310 has a housing 312 that includes a pair of wire attachment portions 316 and 318. Housing 312 is preferably made of a suitable electrical insulating material, such as plastic, including injection molded thermoplastic, and can be a standalone unit or configured to fit within an electrical enclosure. Within the housing 312 are the components that interconnect two or more wires connected via wire attachment portions 316 and 318. Each wire attachment portion 316 and 318 may be secured to or integrally formed into housing 312. According to the present illustrative embodiment, wire attachment portion 316 includes three sets (1-3) of terminal access portions 333. Each terminal access portion includes an actuator opening 334 and associated wire opening (not shown). Each of the three sets may include any number of terminal access portions 333 as desired. For example, each set (1-3) may include “n” number of access portions 333 such that each set is capable of receiving “n” number of cables or wires (700-700n). Each set (1-3) of terminal access portions 333 may have the same number of terminal access portions 333 or may have a different number of terminal access portions 333 as desired. Wire attachment portion 318 may also include any number of terminal access portions 333. According to the present illustrative embodiment, wire attachment portion 318 includes three terminal access portions 333, each including an actuator opening 334 and a wire opening (not shown). Similar to that described herein with respect to other embodiments, housing 312 may include one or more chambers or cavities configured to receive and position a wire termination assembly 200 within housing 312. The chambers or cavities and wire termination assemblies 200 positioned within housing 312 are substantially similar to the corresponding structures described with respect to the above embodiments and for reasons of brevity will not be described again in detail. According to the present illustrative embodiment, in this configuration, each of the wire termination assemblies 200 may be electrically interconnected as illustrated by the phantom lines. As described with respect to previous embodiments, this interconnection may be achieved utilizing one or more individual jumpers and/or appropriately shaped clamp braces 212 (e.g., see FIG. 8). The present illustrative embodiment thus theoretically allows virtually an unlimited number of wires to be attached to a single wire.

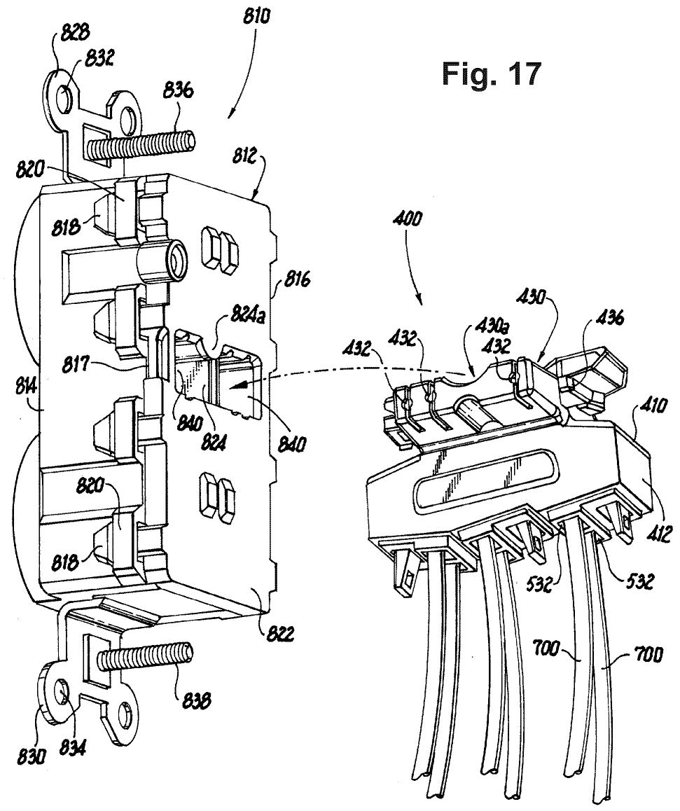

According to another illustrative embodiment of the present disclosure, screwless wire connectors are provided that mate with electrical wiring devices. Referring to FIG. 17-24, an exemplary configuration of an electrical wiring device 810 and a screwless wire connector 400 according to the present disclosure are shown. In this exemplary configuration, the electrical wiring device 810 includes a housing 812 having a cover 814 connected to a base 816. The base 816 can have a plurality of extending posts 818 that are received within pockets 820 of the cover 814 creating a snap fit to secure the cover 814 to the base 816. The base 816 has a rear surface 822, and one or more apertures 824 disposed in the rear surface 822. Aperture 824 is adapted to receive a portion of the screwless connector 400, as will be described in more detail below. Wiring device 810 includes a ground or mounting strap having mounting ears 828 and 830 disposed at opposite ends of the ground strap. Each mounting ear 828 and 830 has one or more openings 832 and 834 to receive fasteners 836 and 838 used to secure the electrical wiring device 810 to an electrical box in a conventional manner. The ground strap may be disposed between the cover 814 and the base 816, or the ground strap may wrap around the rear surface 822 of the base 816 and up along the sides of the cover 814. Known components that form the operational features of the electrical wiring device 810 are provided within housing 812. For example, if the electrical wiring device 810 is a duplex receptacle, the internal components of the receptacle would include flexible contacts forming female contact assemblies accessible via openings provided in cover 814 for receiving a plug from an electrical apparatus or appliance to be powered. The female contact assemblies are electrically connected with respective contact blades 840 accessible via one or more apertures 824 provided in base 816.

In the exemplary configuration of FIG. 17, the electrical wiring device 810 is a duplex receptacle, such that the cover 814 of the housing 812 has two sets of receptacles each having three openings to receive an electrical plug of an electrical apparatus or appliance to be powered by the electrical wiring device 810. For each of the two sets of receptacles, one of the three openings has a female contact assembly that connects to the hot leg of the power wires, one of the three openings has a female contact assembly that connects to the neutral leg of the power wires, and one of the three openings has a female contact assembly that connects to ground. The respective contact assemblies of each of the two receptacles are interconnected with each other and are interconnected to respective contact blades 840 accessible via the one or more apertures 824 provided in base 816. For example, the hot legs are interconnected to each other and to a contact blade 840 accessible via aperture 824. The neutral legs are interconnected to each other and to a contact blade 840 accessible via aperture 824. The grounds are interconnected to each other and to a contact blade 840 accessible via aperture 824. The three contact blades 840 are arranged so that two outer contact blades 840 correspond to hot and neutral contact assemblies within the housing 812, and a middle contact blade 840 corresponds to a ground contact assembly within the housing 812. When the screwless connector 400 is mated with the electrical wiring device 810, the hot contact assemblies of wire connector 400 would also be connected to the hot contact blade 840 of wiring device 810, the neutral contact assemblies of wire connector 400 would be connected to the neutral contact blade 840 of wiring device 810, and the ground contact assemblies of wire connector 400 would be connected to the ground contact blade 840 of wiring device 810.

While the configuration shown in FIG. 17 is described as having three contact blades 840, one skilled in the art would readily appreciate that any number of contact blades 840 may be used in the electrical wiring device 810. A more detailed description of the electrical wiring device 810 is provided in commonly owned U.S. Pat. No. 9,130,285, which is incorporated herein in its entirety by reference. Further, the electrical wiring device shown in FIG. 17 and described herein is a duplex receptacle. However, the electrical wiring device 810 used with the screwless connector 400 may be, for example, a single receptacle, a circuit interrupting receptacle, e.g., a GFCI receptacle, a single pole switch, a three-way switch, a dimmer switch, or any similar electrical wiring device. Further, the number of contact blades 840 accessible through the aperture(s) 824 would depend upon the particular electrical wiring device 810 to which the screwless connector 400 is to connect. For example, if the electrical wiring device 810 were a single pole switch, there would be three contact blades 840 accessible through the aperture(s) 824. One contact blade 840 would be for the hot leg, one contact blade 840 would be for the neutral leg, and one contact blade 840 would be for the ground. As another example, if the electrical wiring device 810 were a three-way switch, there would be four contact blades 840 accessible through the aperture(s) 824. One contact blade 840 would be for the hot leg, two contact blades 840 would be for traveler legs, and one contact blade 840 would be for the ground.

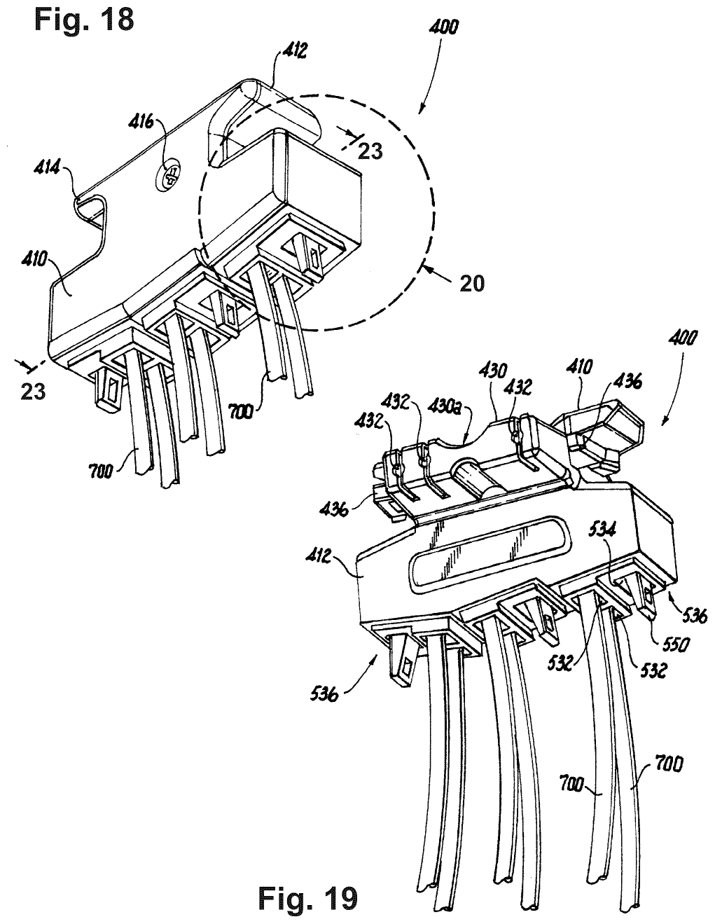

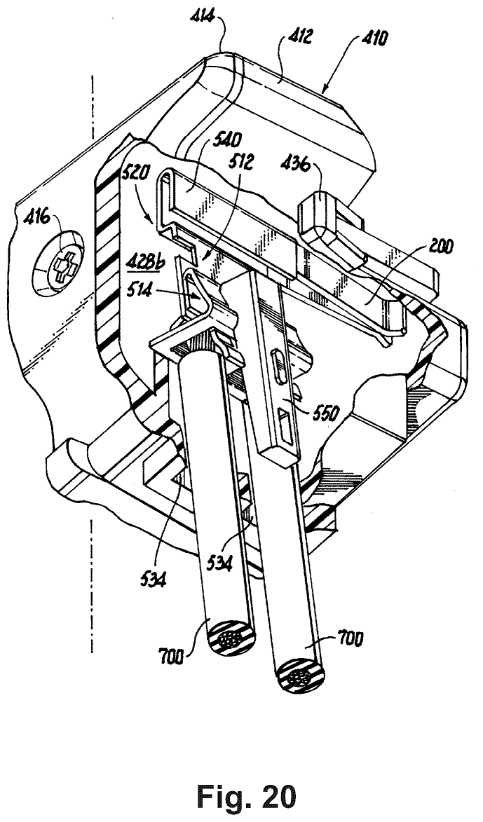

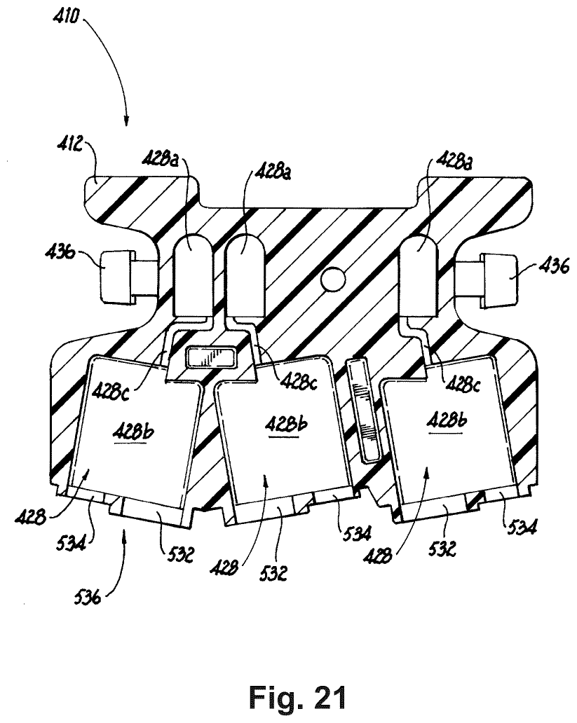

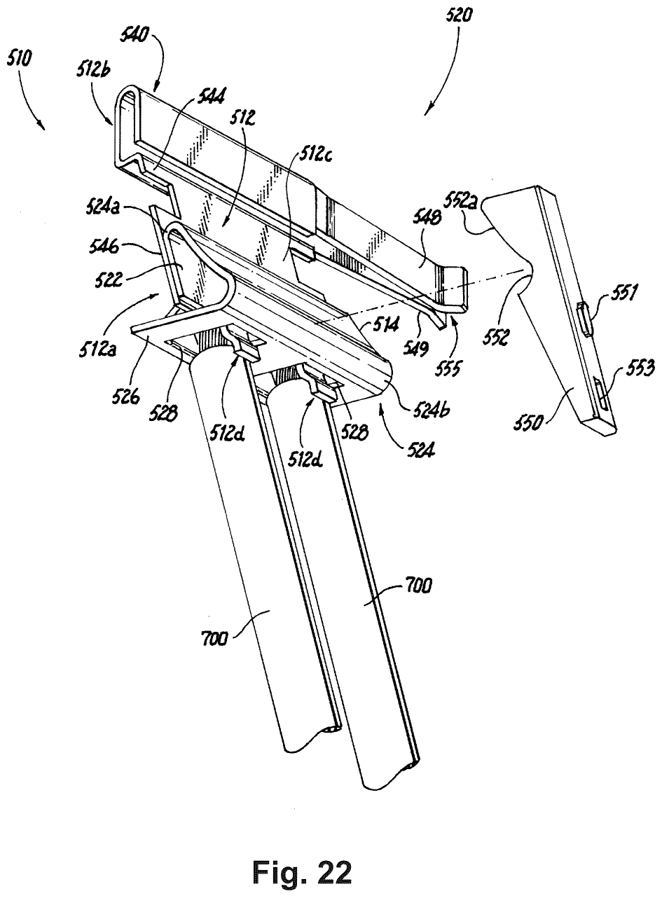

A screwless connector according to an illustrative embodiment of the present disclosure is shown in FIGS. 17-24 and is referred to as screwless connector or just connector 400. The screwless connector 400 includes a terminal housing 410 and a plurality of contact assemblies 520 (e.g., see FIGS. 20, 22-24) within the terminal housing 410. As seen in FIGS. 18 and 20, the terminal housing 410 has a base 412 and a cover 414 that connects to the base 412. The terminal housing 410 is preferably made of a non-conductive material, such as injection molded thermoplastic. The base 412 can be secured to the cover 414 using mechanical fasteners, adhesives, or welds such as sonic welds. In the configuration shown, a mechanical fastener 416 such as a screw may be used to secure cover 414 to a mounting aperture (not shown) in the base 412. As shown in FIG. 21, the base 412 includes one or more cavities 428 each including a first cavity 428a, a second cavity 428b and an interconnect cavity or slot 428c each configured to receive a portion of the contact assembly 520, seen in FIGS. 22-24.

In the configuration of FIGS. 17-24, the base 412 of terminal housing 410 has three cavities 428, each configured to receive one contact assembly 520. Preferably, the screwless connector 400 has three contact assemblies 520 corresponding to the hot, neutral and ground power wires 700. According to the present illustrative embodiment, each contact assembly 520 is capable of receiving and securing two wires 700. As a result, the screwless connector 400 can terminate six wires-two hot wires, two neutral wires and two ground wires. It will be appreciated that the base 412 of terminal housing 410 may have one cavity, two cavities, or more than three cavities each for receiving one or more contact assemblies 520. A plurality of apertures or wire openings 532 are formed in the base 412 to receive wires 700 and to provide access to contact assemblies 520. The wire openings 532 are preferably disposed on the same side of the base 412 and extend through a bottom surface 536 of the base 412 to a respective cavity 428b within the base 412, as shown in FIG. 21. As shown in FIGS. 18 and 19, two wire openings 532 are provided to each cavity 428 to provide access for two wires to each contact assembly 520 positioned within cavity 428b. Each wire opening 532 may be angled relative to their respective cavity 428b. An actuator aperture or opening 534 is provided on the same side of the base 412 adjacent each pair of wire openings 532 and extend from a bottom surface 536 of the base 412 to a respective cavity 428b within the base 412. According to the present illustrative embodiment of the present disclosure, three actuator apertures or openings 534 are provided.

Referring to FIGS. 17 and 19, the base 412 also includes a plug connector 430 that is configured to be inserted into the aperture 824 in the electrical wiring device 810. The plug connector 430 includes one or more openings or slots 432 to receive the contact blades 840 extending into aperture 824 of electrical wiring device 810. The plug connector 430 includes access to portions of the cavities 428 (e.g., cavities 428a) for receiving flexible contacts 548 and 549, seen in FIG. 22, of the contact assembly 520 as will be described later below. The flexible contacts 548 and 549 form a female contact that can receive the contact blade 840 extending within aperture 824, which in this exemplary configuration is a male contact.

As shown in FIG. 17, the base 412 also includes a pair of latching arms 436 which are disposed on opposite sides of the base 412. The latching arms 436 are flexible members that facilitate latching the screwless connector 400 to the electrical wiring device 810, and that facilitate unlatching the screwless connector 400 from the electrical wiring device 810. In particular, the latching arms 436 are configured to interact with overhangs 817 positioned on the sides of the base 816 adjacent to aperture 824. Interaction between the overhangs 817 and the latching arms 436 releasably latches the screwless connector 400 to the electrical wiring device 810. More specifically, when the connector plug 430 of the screwless connector 400 is inserted into the aperture 824, the latching arms 436 flex away from the terminal housing 410 so that the latching arms 436 pass over the overhangs 817 on the base 816, and then snap back when the latching arms 436 pass beyond the overhangs 817. To release the screwless connector 400 from the electrical wiring device 810, the latching arms 436 are flexed away from the terminal housing 410 and overhangs 817 and the connector plug 430 of the screwless connector 400 is pulled out of the aperture 824. According to the present illustrative embodiment, the connector plug 430 may include a keyway, e.g., an arched portion 430a, that aligns with a key, e.g., an inverted arch 824a, in the rear surface 822 of the base 816 of electrical wiring device 810 to ensure that the connector plug 430 is properly aligned with the aperture 824.

Contact assembly 520 according to an illustrative embodiment of the present disclosure is shown in FIGS. 20 and 22-24. Each contact assembly 520 may be configured to receive and clamp at least one wire, such as wire 700. According to the present illustrative embodiment, each contact assembly 520 is configured to receive and clamp two wires 700. As shown in FIG. 24, wire 700 may be an insulated wire including the electrically conductive wire 701 (typically copper, aluminum, etc.), and one or more insulating covers or coats 702. Wire 701 may be stranded or solid. In the exemplary embodiment shown, each contact assembly 520 includes a wire terminal 510 and an actuator 550. Wire terminal 510 may include a clamp brace 512 and a clamping member 514. At least a portion of the wire terminal 510 may be made of an electrically conductive resilient material, such as brass, copper, aluminum or spring steel. In an exemplary embodiment, at least a portion of the wire terminal 510 is made of an electrically conductive resilient material with sufficient stiffness to flex when a mechanical load is applied and return to its normal position when the mechanical load is removed. An example of such an electrically conductive resilient material is spring steel. The clamp brace 512 and clamping member 514 forming wire terminal 510 can be formed as a unitary structure. Alternatively, clamp brace 512 and clamping member 514 can be individual components which together form wire terminal 510. The individual components may be secured together by, for example, a solder joint, a brazed joint, or a welded joint. The actuator 550 is made of a suitable rigid electrical insulating material, such as a plastic material. An example of a plastic material is injection molded thermoplastic. The actuator 550 may also be referred to herein as a “plunger” in the singular and “plungers” in the plural.

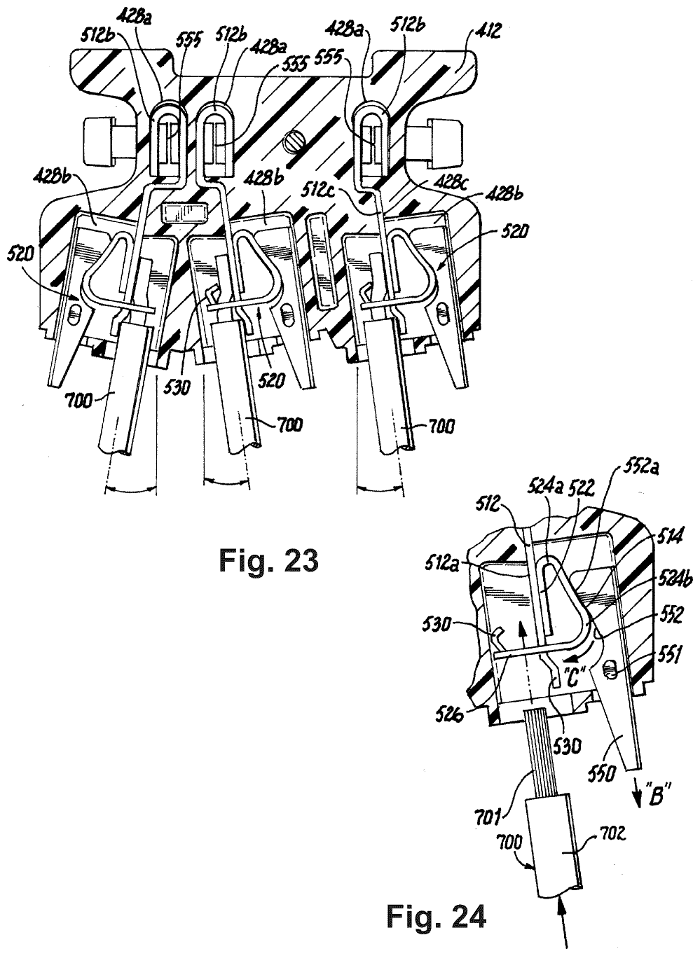

Continuing to refer to FIGS. 20 and 22-24, the wire terminal 510 is a mechanical clamping terminal that may use one or more clamping members 514 that can deflect under a mechanical load applied by the plunger 550 and recover to their initial shape when the mechanical load is removed. The energy stored by the one or more clamping members 514 should be sufficient to apply a constant and continuous force to mechanically secure one or more wires, e.g., wires 701 to the wire terminal 510. In the exemplary configuration shown in FIGS. 20 and 22, the wire terminal 510 includes a clamp brace 512 and a clamping member 514. The clamp brace 512 is a fixed terminal body that may be a substantially planar shaped member or an arcuate shaped member having a first end 512a in electrical contact with the clamping member 514. The clamp brace 512 may be secured to an abutting portion 522 of clamping member 514 by, for example, a solder joint, a brazed joint, or a welded joint. Alternatively, the clamp brace 512 may be urged against abutting portion 522 of clamping member 514 and maintained in contact by the spring action of the materials forming clamp brace 512 and clamping member 514. The clamping member 514 is positioned and maintained in cavity 428b of base 412. The clamp brace 512 has a second end 512b that extends from cavity 428b into cavity 428a of base 412 via interconnect cavity or slot 428c (FIG. 23). Preferably, at least a portion of the middle section 512c of the clamp brace 512 is fixed or secured to the main body of the housing 412 to limit and possibly prevent flexing of the middle section 512c of the clamp brace 512 during use. In the present exemplary embodiment, the portion of the middle section 512c of the clamp brace 512 is positioned within interconnect cavity or slots 428c of the main body portion 414 (e.g., see FIG. 23). By securing the middle section 512c of the clamp brace 512 to the main body portion 414, flexing of the middle section 512c is limited or prevented.

Referring to FIGS. 20-24, in the exemplary embodiment shown, the clamping member 514 may be a biasing member. In the present embodiment, the biasing member is a spring that includes an end abutting portion 522, a spring member 524 and a clamp arm 526. The end abutting portion 522 can be a substantially planar shaped member or an arcuate shaped member that is configured to mate with the clamp brace 512 and as described above, may be secured to the clamp brace 512 by, for example, a solder joint, a brazed joint, or a welded joint. The spring member 524 has a lower lobe 524a and an upper lobe 524b. The lower lobe 524a and the upper lobe 524b are configured to interact with the plunger 550 so that movement of the plunger 550 relative to the spring member 524 is translated to the application of a mechanical load on the spring member 524 or the removal of at least a portion of the mechanical load on the spring member 524.

The plunger 550 can be a rectangular shaped member having one or more longitudinal raised ribs 551 extending along the top and or side portions of plunger 550. Each longitudinal raised rib 551 is slidingly received in a corresponding notch or groove (not shown) provided along an inside side surface of housing 412. Plunger 550 may also include an orifice 553 extending therethrough. Orifice 553 is dimensioned to allow a tool (e.g., a screwdriver) to be inserted therein to provide the operator of the device with additional leverage for moving the plunger 550 between the open and closed positions. Plunger 550 includes a notch 552 that is configured to receive the upper lobe 524b of the spring member 524, as shown in FIGS. 22-24. The notch 552 has a camming surface 552a that rides along the spring member 524 when the plunger 550 is moved in the direction of arrow “B,” (FIG. 24) applying a mechanical load on the spring member 524 causing the spring member 524 to deflect in the direction of arrow “C” toward the open position. The clamp arm 526 extends from the upper lobe 524b of the spring member 524 toward the clamp brace 512, as shown. The clamp arm 526 has one or more elongated openings 528 (e.g., see FIG. 22) configured to receive the distal end portions 512d of the clamp brace 512. In the present embodiment, the clamp arm 526 has two elongated openings 528 receiving distal end portions 512d of clamp brace 512. Referring to FIGS. 23 and 24, wire press members 530 extend inward from the clamp arm 526. Wire press members 530 may be formed in situ with elongated openings 528 during manufacture by permanently bending portions of the material cut from elongate openings 528 to form wire press members 530. Alternatively, wire press members 530 may be formed as separate pieces and welded or otherwise connected to clamp arm 526. The wire press members 530 are each configured to contact and press a wire, e.g., wire 701 as seen in FIGS. 23 and 24, against the clamp brace 512 when the wire 701 is positioned between the clamp brace 512 and the wire press members 530 and the plunger 550 is in the closed position, as shown in FIG. 23. The clamp arm 526 is movable relative to the clamp brace 512 between the closed position, seen in FIG. 23, and the open position seen in FIG. 24, by linear movement of plunger 550.

In this exemplary configuration shown in FIG. 22, a contact member 540 extends from clamp brace 512 and is made of one or more electrically conductive material, such as brass, aluminum or, spring steel. Contact member 540 may be made from the same section of material as clamp brace 512 or from a different section of material joined to clamp brace 512 by, for example, a solder joint, a brazed joint, or a welded joint. The contact member 540 includes a connecting body 544 having a pair of flexible contacts 548 and 549 extending toward slots 432 in connector plug 430 as shown in FIG. 17. At least a portion of the contact body 540 forming flexible contacts 548 and 549 is made of an electrically conductive resilient material with sufficient stiffness to flex when a mechanical load is applied and return to its normal position when the mechanical load is removed. Flexible contacts 548 and 549 form a female contact configured to engage a contact blade 840 accessible via aperture 824 in the electrical wiring device 810. In particular, the flexible contacts 548 and 549 of the contact member 540 contact each other to form a gripping portion 555 between the contacts, that is capable of receiving a contact blade 840, so as to electrically couple or connect the contact member 540 to the contact blade 840. The gripping portion 555 between flexible contacts 548 and 549 is accessible via slots 432 in the connector plug 430. Thus, each contact assembly 520 is adapted to engage one of the plurality of contact blades 840 in the electrical wiring device 810 when the screwless wire connector 400 is mated with the electrical wiring device 810.

As noted, the wire terminal 510 can connect to electrical conductors of different sizes. For example, if the electrical wiring 700 is rated for 20 amps, then the wire terminal 510 should also be configured and rated for at least 20 amps. The wire size, i.e., the bare conductor size, for 20 amps is 12 AWG wire such that the clamp arm 526 should be able to move to an open position where the outer diameter of 12 AWG wire can fit. As another example, if the electrical wiring 700 is rated for 30 amps, then the wire terminal 510 should also be rated for at least 30 amps. The wire size, i.e., the bare conductor size, for 30 amps is 10 AWG wire such that the clamp arm 526 should be able to move to an open position where the outer diameter of 10 AWG wire can fit. As another example, if the electrical wiring 700 is rated for 40 amps, then the wire terminal 510 should also be rated for at least 40 amps. The wire size, i.e., the bare conductor size, for 40 amps is 8 AWG wire such that the clamp arm 526 should be able to move to an open position where the outer diameter of 8 AWG wire can fit.

The spring member 524 is made of an electrically conductive resilient material with sufficient stiffness to flex when the plunger 550 pushes the spring member 524 from the closed position, seen in FIG. 23, to the open position, seen in FIG. 24. As noted, when in the closed position, the spring member 524 applies a force (e.g., a spring force) through the wire press members 530 to the bare wire conductors 701 inserted between the wire press member 530 and the clamp brace 512, as shown in FIG. 23. As an example, the spring member 524 can be made of spring steel. The biasing force (, e.g., spring force) exerted by the spring member 524 clamping a wire 701 between the wire press members 530 and the clamp brace 512 should be sufficient to apply a constant and continuous force on the wire 701 to electrically couple or connect the wire 701 to the wire terminal 510 in various temperatures and environmental conditions. The upper lobe 524b of spring member 524 is configured so that it is normally biased toward the closed position, e.g., in the direction which is away from the clamp brace 512. In the normal position of the spring member 524 without a conductor inserted into the elongated opening 528, the wire press members 530 of the clamp arm 526 can contact the clamp brace 512.

To connect or mate the screwless connector 400 to the electrical wiring device 810, the installer aligns the connector plug 430 with the aperture 824 in the electrical wiring device 800. As noted above, in the configuration of the connector plug 430 shown in FIG. 17, the connector plug 430 may include a keyway, e.g., an arched portion 430a, that aligns with a key, e.g., an inverted arch 824a, in the rear surface 822 of the base 816 to ensure that the connector plug 430 is properly aligned with the aperture 824. When the connector plug 430 is properly aligned with the aperture 824, force is applied to the terminal housing 410 so that the connector plug 430 enters the aperture 824, and the contact blades 840 slide into the slots 432 in the connector plug 430 and into the gripping portion 555 between the flexible contacts 548 and 549, seen in FIG. 22. When the connector plug 430 of the screwless connector 400 is fully within the aperture 824, the latching arms 436 flex away from the terminal housing 410 so that the latching arms 436 pass over the overhangs 817 on the base 816, and then snap back when the latching arms 436 pass beyond the overhangs 817. At this point, the screwless connector 400 is latched to the electrical wiring device 810. To release the screwless connector 400 from the electrical wiring device 810, the latching arms 436 are flexed away from the terminal housing 410 and the screwless connector 400 is pulled out of the aperture 824.

The wires 700 terminated by the screwless connector 400 extend from the base 412 of the terminal housing 410 and substantially perpendicular to the connector plug 430, as seen in FIG. 23. As such, the plurality of wires 700 are substantially parallel to a longitudinal axis of the electrical wiring device 810 when the screwless connector 400 is connected to the electrical wiring device 810. Having the wires 700 substantially parallel to a longitudinal axis of the electrical wiring device 810 provides more area within an electrical box in which to mount the electrical wiring device. Alternatively, the wires 700 can be terminated such that the wires extend from the base 412 of the terminal housing 410 and are substantially perpendicular to the longitudinal axis of the electrical wiring device 810.

Using the electrical wiring device and screwless connector of the present disclosure, power wires can be quickly and easily inserted into the screwless connector, and the screwless connecter can be quickly and easily connected to the electrical wiring device. As a result, electrical continuity can be established between the existing power wires and the electrical wiring device quickly and easily. While illustrative configurations of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. A terminal block comprising:
a housing having an interior, a plurality of wire openings and a plurality of actuator openings, wherein at least a portion of the interior is hollow, wherein each of the plurality of wire openings provides access from an exterior of the housing to the hollow portion of the interior of the housing, and wherein each of the plurality of actuator openings provides access from the exterior of the housing to the hollow portion of the interior of the housing; and
a plurality of wire termination assemblies positioned in the hollow portion of the interior of the housing such that one of the plurality of wire termination assemblies is accessible from one of the plurality of wire openings and one of the plurality of actuator openings;
wherein each of the plurality of wire termination assemblies comprises:
a wire terminal including a clamp brace electrically connected to a clamping member, the clamping member being movable between a closed position where a wire can be clamped between the clamping member and the clamp brace, and an open position where the wire can be inserted through the one of the plurality of wire openings in the housing and between the clamping member and the clamp brace; and
an actuator extending at least partially through the one of the plurality of actuator openings in the housing, the actuator being interactive with the clamping member such that movement of the actuator in a first direction causes the actuator to apply a mechanical load to the clamping member causing the clamping member to move from the closed position to the open position, and movement of the actuator in a second direction removes the mechanical load from the clamping member so that the clamping member moves from the open position to the closed position; and
wherein a clamp brace of at least one of the plurality of wire terminal assemblies is electrically connected to a clamp brace of at least one other of the plurality of wire terminal assemblies.

2. The screwless terminal block according to claim 1, wherein the clamping member comprises a biasing member.

3. The screwless terminal block according to claim 1, wherein the actuator remains in the first position or the second position until manually moved.

4. The screwless terminal block according to claim 1, wherein the movement of the actuator in the first direction and the second direction is linear.

5. The screwless terminal block according to claim 4, wherein the linear movement of the actuator is relative to the clamping member.

6. The screwless terminal block of claim 1, wherein the clamp brace of at least one of the plurality of wire terminal assemblies is electrically connected to clamp braces of a plurality of wire terminal assemblies.

7. The screwless terminal block of claim 1, wherein when in the closed position the clamping member can clamp the wire with a force that is substantially perpendicular to a longitudinal axis of the wire.

8. A wire connector, comprising:
a housing comprising:
at least one cavity;
at least one housing wire opening and at least one actuator opening extending between the at least one cavity and an outer surface of the housing, wherein the at least one housing wire opening is arranged at an angle relative to the at least one cavity;
a plug member for mating with an electrical wiring device, wherein at least a portion of the plug member includes a portion of the at least one cavity, and wherein the plug member has at least one slot for receiving a contact blade aligned with the portion of the at least one cavity; and
at least one contact assembly positioned within the at least one cavity, the at least one contact assembly comprising:
a wire terminal including a clamp brace electrically connected to a clamping member, the clamping member being movable between a closed position where a wire can be clamped between the clamping member and the clamp brace, and an open position where the wire can be inserted through the at least one housing wire opening and between the clamping member and the clamp brace; and
an actuator extending at least partially through at the at least one of the plurality of actuator openings in the housing, the actuator being interactive with the clamping member such that movement of the actuator in a first direction causes the actuator to apply a mechanical load to the clamping member causing the clamping member to move from the closed position to the open position, and movement of the actuator in a second direction removes the mechanical load from the clamping member so that the clamping member moves from the open position to the closed position; and
wherein a clamp brace of at least one of the plurality of wire terminal assemblies is electrically connected to at least one flexible contact positioned within the plug member for receiving the contact blade.

9. The screwless wire connector according to claim 8, wherein the at least one cavity comprises a first cavity, a second cavity and a third cavity.

10. The screwless wire connector according to claim 9, wherein the at least one housing wire opening comprises three housing wire openings, wherein a first housing wire openings extends between the first cavity and the outer surface of the housing and is arranged at an angle relative to the first cavity, wherein a second housing wire openings extends between the second cavity and the outer surface of the housing and is arranged at an angle relative to the second cavity, and wherein a third housing wire openings extends between the third cavity and the outer surface of the housing and is arranged at an angle relative to the third cavity.

11. The screwless wire connector according to claim 9, wherein the plug member has three slots, wherein a first slot is aligned with a portion of the first cavity, a second slot is aligned with a portion of the second cavity, and a third slot is aligned with a portion of the third cavity.

12. The screwless wire connector according to claim 11, wherein the at least one contact assembly comprises a first contact assembly positioned in the first cavity, a second contact assembly positioned in the second cavity, and a third contact assembly positioned in the third cavity.

13. The screwless wire connector according to claim 8, wherein the clamping member comprises a biasing member.

14. The screwless wire connector according to claim 8 wherein the actuator remains in the first position or the second position until manually moved.

15. The screwless wire connector according to claim 8, wherein the movement of the actuator in the first direction and the second direction is linear.

16. The screwless wire connector according to claim 15, wherein the linear movement of the actuator is relative to the clamping member.
